(19) United States
(12) Patent Application Publication
(10) Pub. No.: US 2021/0187633 A1
(43) Pub. Date: Jun. 24, 2021

(54) ROTARY CUTTING TOOL INSERT

(71) Applicant: Decatur Diamond, LLC, Decatur, IN (US)

(72) Inventor: Gabriel Dontu, Ann Arbor, MI (US)

(21) Appl. No.: 17/127,214

(22) Filed: Dec. 18, 2020

Related U.S. Application Data
(60) Provisional application No. 62/949,913, filed on Dec. 18, 2019.
(60) Provisional application No. 62/949,889, filed on Dec. 18, 2019.
(60) Provisional application No. 62/949,894, filed on Dec. 18, 2019.

(51) Int. Cl. B23C 5/10; B23B 51/02

(52) U.S. Cl. CPC B23C 5/109; B23B 51/02; B23C 2222/28; B23B 2222/28; B23C 2200/28; B23B 2200/28

(57) ABSTRACT

A rotary cutting tool cutting insert is provided that includes front, aft, exterior, and interior side surfaces, an axial end surface, and a base surface. The exterior side surface intersects with the front side surface. The interior side surface intersects with the front side surface. The axial end side surface intersects with the front side surface at an axial end cutting edge, with the exterior side surface at a first outer axial edge, and with the interior side surface at a second outer axial edge. The base surface intersects the front, exterior, and interior side surfaces and the aft surface. The base surface intersects the front side surface at an inner edge. An outer radial tip is disposed at a first heightwise distance from an inner edge, and an inner radial tip is disposed at a second heightwise distance from the inner edge.

### CROSS-REFERENCE TO RELATED APPLICATIONS

This application claims priority to U.S. Provisional Patent Application No. 62/949,913 filed Dec. 18, 2019, and to U.S. Provisional Patent Application No. 62/949,889 filed Dec. 18, 2019, and to U.S. Provisional Patent Application No. 62/949,894 filed Dec. 18, 2019, each of which is hereby incorporated by reference in its entirety.

### BACKGROUND OF THE INVENTION

### 1. Technical Field

The present invention pertains in general to cutting processes and tools for removing a cylinder of material from a substrate, and in particular to rotational cutting tools and inserts therefore configured to remove a cylinder of material from a substrate, which tools are configured for use with a cutting fluid.

### 2. Background Information

Rotary cutting tools are often used to produce an aperture extending through a substrate. A well-known example of such a rotary cutting tool is a twist drill. Twist drills typically include a shank portion disposed adjacent a first axial end and a cutting portion disposed adjacent a second axial end. The cutting portion terminates at tapered surfaces that form a point angle. Cutting edges helically extend through the cutting portion and helical flutes provide passages along the cutting portion. Axial force is applied to the twist drill as it is rotating, and the drill operates to remove material and create the aperture. In instances where a rotating cutting tool such as a twist drill is used to produce a through aperture within a substrate, surface imperfections (splintering, fracturing, etc.) adjacent the substrate exit of the aperture are commonly produced as the drill breaks through the surface. These exit surface imperfections may be produced in many substrate material types, but can be particularly pronounced in wooden or composite substrates. The surface imperfections are produced, at least in part, by outwardly radial forces applied to the substrate by the tapered point. These surface imperfections can create unacceptable surface irregularities and stress concentration factors. In instances where apertures are produced in composite substrates produced for load bearing structures, stress concentration factors can be a significant concern. Very often it is necessary to add further manufacturing processes (e.g., deburring, chamfering, etc.) to address the surface imperfections and the concomitant stress concentration factors. The additional processes add cost and time to the manufacturing process.

Another type of rotary cutting tool used to create an aperture within a substrate is typically referred to as a “core drill”. Many core drills utilize a cylindrical cutter having teeth disposed at an axial end. As the teeth cut into the substrate, a “plug” of the substrate is disposed within the interior of the cylindrical cutter. As the cylindrical cutter breaks through the opposing substrate surface, the plug becomes independent from the substrate and can removed. Many core drills also produce undesirable surface imperfections adjacent the exit of the aperture as described above.

Friction between a rotary cutting tool (e.g., a twist drill, a core drill, etc.) and a substrate typically produces thermal energy, thereby causing the rotary cutting tool and the substrate to increase in temperature. The increase in temperature can be particularly problematic for resin-based composite substrates. If the temperature of the substrate and the incorporated resin is excessively increased, the material properties of the composite can be detrimentally altered. For example, in some instances excessive heat can cause thermal decomposition of the resin matrix which in turn can result in a depletion of the structural integrity of the composite.

What is needed is a rotary cutting tool that can be used to create a through aperture with minimal or no surface irregularities at the exit of the aperture.

### SUMMARY

According to an aspect of the present disclosure, a rotary cutting tool cutting insert is provided that includes a front side surface, an aft side surface, an exterior side surface, an interior side surface, an axial end surface, and a base surface. The aft side surface is opposite the front side surface. The exterior side surface intersects with the front side surface at an exterior cutting edge. The interior side surface intersects with the front side surface at an interior cutting edge, wherein the interior side surface is opposite the exterior side surface. The axial end side surface intersects with the front side surface at an axial end cutting edge, intersects with the exterior side surface at a first outer axial edge, and intersects with the interior side surface at a second outer axial edge. The base surface intersects the front side surface, the exterior side surface, the interior side surface, and the aft surface. The base surface intersects the front side surface at an inner edge, and the base surface is opposite the axial end side surface. The insert has a height axis that extends between the axial end side surface and the base surface, a width axis that extends between the exterior side surface and the interior side surface, and a depth axis that extends between the front side surface and the aft surface, and the height, width, and depth axes are orthogonal one another. An outer radial tip is disposed at a first widthwise end of the axial end cutting edge, and an inner radial tip is disposed at a second widthwise end of the axial end cutting edge. The outer radial tip is disposed at a first heightwise distance from the inner edge, and the inner radial tip is disposed at a second heightwise distance from the inner edge, and the first heightwise distance is greater than the second heightwise distance.

In any of the aspects or embodiments described above and herein, the axial end cutting edge may be skewed by an acute radial cutting angle, wherein the radial cutting angle is defined by the axial end cutting edge and a widthwise extending line parallel to the base surface.

In any of the aspects or embodiments described above and herein, the front side surface may be skewed by an acute axial rake angle, wherein the axial rake angle is defined by the front side surface and a heightwise extending line parallel to the aft surface.

In any of the aspects or embodiments described above and herein, the front side surface may extend heightwise between the axial end cutting edge and an inner edge, and the axial end cutting edge is disposed depthwise outside of the inner edge.

In any of the aspects or embodiments described above and herein, the front side surface may be skewed by an acute radial rake angle, wherein the radial rake angle is defined by the front side surface and a widthwise extending line parallel to the aft surface.

In any of the aspects or embodiments described above and herein, the exterior cutting edge may be disposed depthwise outside of the interior cutting edge.

In any of the aspects or embodiments described above and herein, the axial end surface may be skewed by an acute axial end surface relief angle, wherein the axial end surface relief angle is defined by the axial end surface and a depthwise extending line that is perpendicular to aft surface.

In any of the aspects or embodiments described above and herein, the axial end side surface may intersect with the aft surface at an aft edge, and the axial end surface may extend depthwise between the axial end cutting edge and the aft edge, and wherein the axial end cutting edge may be disposed heightwise outside of the inner edge of the front side surface.

In any of the aspects or embodiments described above and herein, the exterior side surface may be skewed by an acute exterior side surface radial relief angle, wherein the exterior side surface radial relief angle is defined by the exterior side surface and a depthwise extending line that is perpendicular to the aft surface.

In any of the aspects or embodiments described above and herein, the exterior side surface may extend depthwise between the exterior cutting edge and an aft edge, and the exterior cutting edge may be disposed widthwise outside of the aft edge.

In any of the aspects or embodiments described above and herein, the interior side surface may be skewed by an acute interior side surface radial relief angle, wherein the interior side surface radial relief angle is defined by the interior side surface and a depthwise extending line that is perpendicular to the aft surface.

In any of the aspects or embodiments described above and herein, the interior side surface may extend depthwise between the interior cutting edge and an aft edge, and the interior cutting edge may be disposed widthwise outside of the aft edge.

In any of the aspects or embodiments described above and herein, the exterior side surface may be skewed by an acute exterior side surface axial relief angle, wherein the exterior side surface axial relief angle is defined by the exterior side surface and a line perpendicular to the base surface.

In any of the aspects or embodiments described above and herein, the exterior side surface may extend heightwise between an outer axial edge and an inner axial edge, and the outer axial edge may be disposed widthwise outside of the inner axial edge.

In any of the aspects or embodiments described above and herein, the interior side surface may be skewed by an acute interior side surface axial relief angle, wherein the interior side surface axial relief angle is defined by the interior side surface and a line perpendicular to the base surface.

In any of the aspects or embodiments described above and herein, the interior side surface may extend heightwise between an outer axial edge and an inner axial edge, and the outer axial edge may be disposed widthwise outside of the inner axial edge.

In any of the aspects or embodiments described above and herein, the insert may comprise a superhard material.

In any of the aspects or embodiments described above and herein, the insert may comprise a carbide material.

In any of the aspects or embodiments described above and herein, the insert may include a plurality of insert portions attached to one another.

In any of the aspects or embodiments described above and herein, the insert may be a unitary body.

These and other objects, features and advantages of the present invention will become apparent in light of the detailed description of the invention provided below, and as illustrated in the accompanying drawings.

### BRIEF DESCRIPTION OF THE DRAWINGS

FIG. 1 is a perspective view of a present disclosure rotary cutting tool embodiment.

FIG. 2 is a planar view of a present disclosure rotary cutting tool embodiment.

FIG. 2A is a planar view of a present disclosure rotary cutting tool embodiment.

FIG. 3 is a diagrammatic sectional view of the present disclosure rotary cutting tool embodiment shown in FIG. 2.

FIG. 4 is an end view of a present disclosure rotary cutting tool embodiment from the cutting end.

FIG. 4A is an expanded view of a portion of the present disclosure rotary cutting tool embodiment shown in FIG. 4.

FIG. 5 is the end view of a present disclosure rotary cutting tool embodiment shown in FIG. 4.

FIG. 5A is an expanded view of a portion of the present disclosure rotary cutting tool embodiment shown in FIG. 5.

FIG. 6 is a partial planar view of the cutting portion of a present disclosure rotary cutting tool embodiment.

FIG. 6A is an expanded view of a portion of the present disclosure rotary cutting tool embodiment shown in FIG. 6.

FIG. 6B is the expanded view of FIG. 6A, with the inserts removed to show the pocket.

FIG. 7 is a partial planar view of the cutting portion of a present disclosure rotary cutting tool embodiment.

FIG. 7A is an expanded view of a portion of the present disclosure rotary cutting tool embodiment shown in FIG. 7.

FIG. 8 is a perspective view of a present disclosure rotary cutting tool embodiment.

FIG. 9 is a perspective view of a present disclosure rotary cutting tool embodiment.

FIG. 9A is an expanded view of a portion of the present disclosure rotary cutting tool embodiment shown in FIG. 9.

FIG. 9B is an expanded view of a portion of the present disclosure rotary cutting tool embodiment shown in FIG. 9.

FIG. 10 is a diagrammatic view of a present disclosure rotary cutting tool embodiment.

FIG. 11 is a diagrammatic perspective view of a rotary cutting tool insert.

FIG. 11A is a diagrammatic front side view of the rotary cutting tool insert shown in FIG. 11.

FIG. 11B is a diagrammatic top side view of the rotary cutting tool insert shown in FIG. 11.

FIG. 11C is a diagrammatic right side view of the rotary cutting tool insert shown in FIG. 11.

FIG. 11D is a diagrammatic left side view of the rotary cutting tool insert shown in FIG. 11.

### DETAILED DESCRIPTION

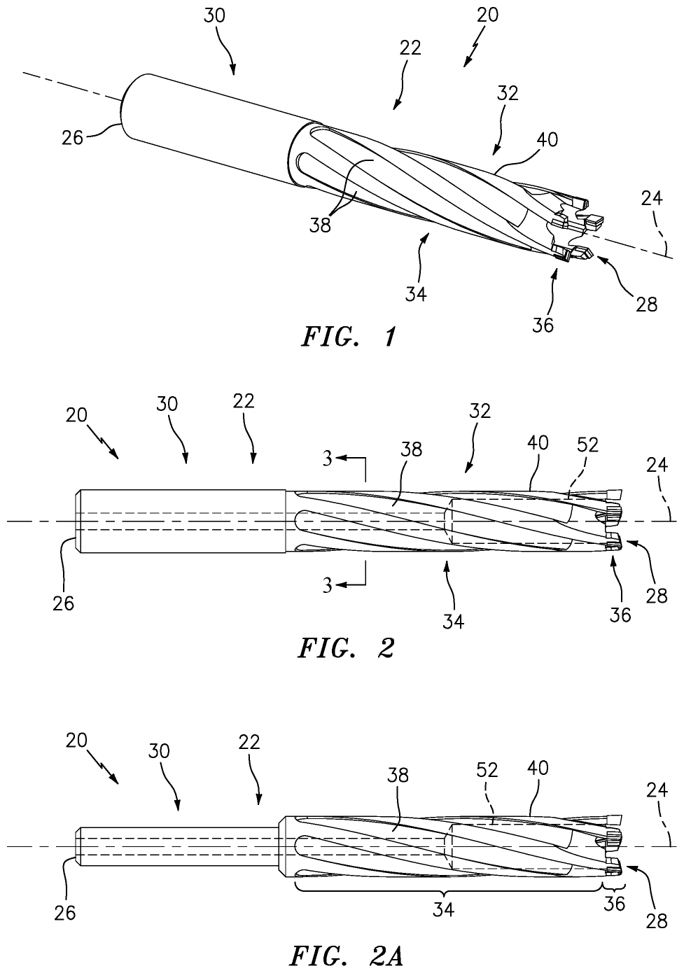

Referring to FIGS. 1-3, a rotary cutting tool 20 includes a body 22 that extends lengthwise along a central axis 24 between a shank end 26 and an opposite cutting end 28. The body 22 includes a shank portion 30 and a cutting portion 32. The shank portion 30 typically extends from the shank end 26 to the cutting portion 32, and the cutting portion 32 extends from the cutting end 28 to the shank portion 30. In some embodiments, the rotary cutting tool 20 may include a relief section (not shown) disposed between the shank portion 30 and the cutting portion 32. The shank portion 30 is typically configured to facilitate attachment within a rotationally driven clamping device (sometimes referred to as a “chuck”). The rotary cutting tools 20 shown in the FIGURES have a cylindrically shaped shank portion 30, but the present disclosure rotary cutting tool 20 is not limited to a cylindrically shaped shank portion 30; e.g. in some embodiments the shank portion 30 may include one or more planar surfaces that facilitate securing the rotary cutting tool 20 within the clamping device (e.g., a driving tang), or the shank portion 30 may have a multi-planar configuration (e.g., hexagonal), etc. FIGS. 1 and 2 illustrate a rotary cutting tool 20 embodiment having a shank portion 30 with an outer diameter that is approximately equal to the outer diameter of the cutting portion 32. The present disclosure is not limited to such rotary cutting tools 20; e.g., the outer diameter of the shank portion 30 (or other widthwise dimension for non-circular shanks) may not equal the outer diameter of the cutting portion 32. The rotary cutting tool 20 shown in FIG. 2A, for example, has a shank portion 30 with an outer diameter that is smaller than the outer diameter of the cutting portion 32.

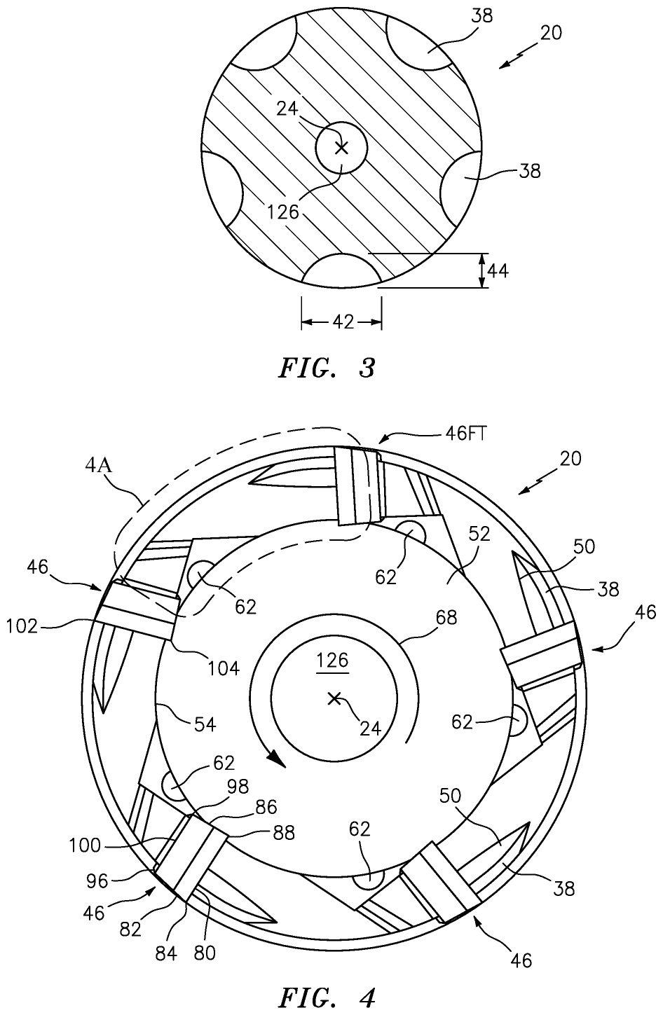

The cutting portion 32 includes a fluted section 34 and a cutting teeth section 36. The fluted section 34 has a plurality of flutes 38 disposed into an exterior surface 40. The exterior surface 40 may be described as having an outer diameter and therefore a radius that extends perpendicular to the central axis 24. The outer diameter may be defined by the outermost radial points of the fluted section 34; e.g., when the rotary cutting tool 20 is rotated about its central axis 24, the outer most points of the fluted section 34 define the outer diameter of the fluted section 34. The cross-section shown in FIG. 3 diagrammatically shows a plurality of flutes 38, each having a cross-section with an arcuate shape, but the present disclosure in not limited to any particular flute 38 shape. The flutes 38 are spaced apart from one another around the circumference of the exterior surface 40; e.g., equi-spaced from one another. Each flute 38 may be described as having a width 42, a depth 44, and a widthwise cross-sectional area. In the embodiment shown in FIGS. 1-3, the flutes 38 extend helically along the exterior surface 40. As will be explained below, each helically extending flute 38 has a tip end that is disposed adjacent a respective tooth 46 and is configured to provide a passage for removal of cutting fluid and cutting debris. As will be described below, the teeth 46 are circumferentially spaced apart from one another, with a void (sometimes referred to as a “gullet 48”) disposed between each set of adjacent teeth 46. The base surface of the gullet 48 may include one or more transitional surfaces 50 that create an entry to the tip end of the respective flute 38. Hence, each respective flute 38 (at its tip end) is in communication with a respective gullet 48. The present disclosure is not limited to helically extending flutes 38, however; e.g., other axially extending flutes 38 may be included alternatively. As will be described below, each flute 38 is configured to provide a fluid passage.

The cutting portion 32 further includes an internal cavity 52 disposed within the body 22, extending inwardly from the cutting end 28. The internal cavity 52 is defined by an interior wall surface 54 and a base 56. The interior wall surface 54 extends axially away from the base 56, towards the cutting end 28. The rotary cutting tool 20, including the internal cavity 52, is configured such that during the cutting process, a “plug 58” (e.g., see FIG. 10) of substrate material enters the internal cavity 52. As will be described below, once the aperture is cut through the entire thickness of the substrate 60, the substrate plug 58 cut in the process is readily removable from the internal cavity 52; e.g., by fluid pressure acting on the plug 58.

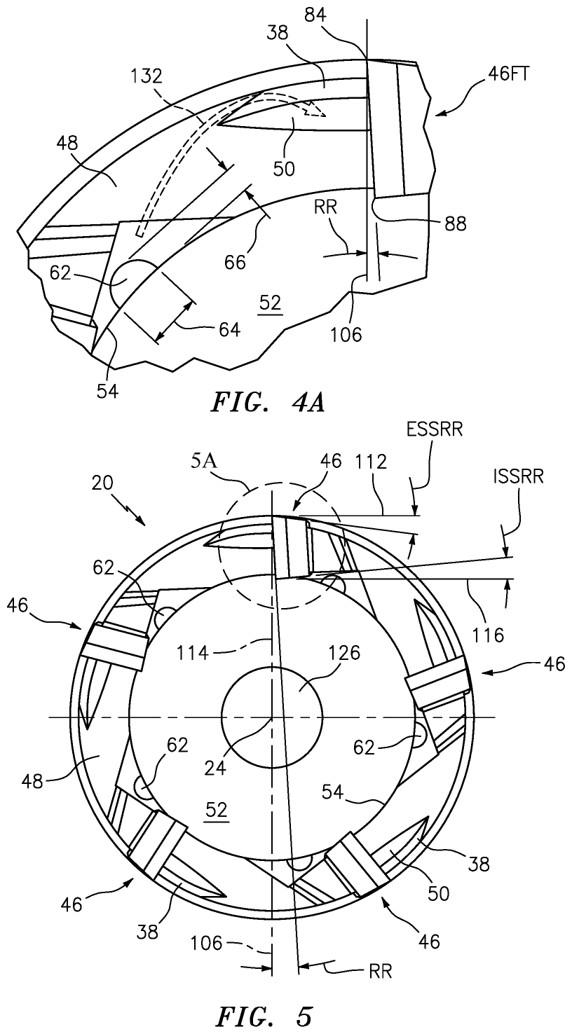

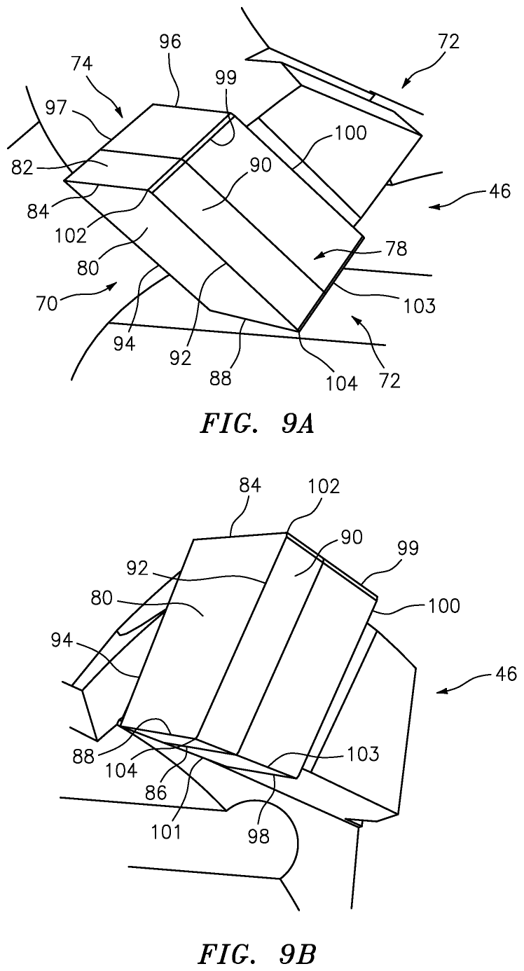

A plurality of channels 62 are disposed in the interior wall surface 54. The channels 62 are open to the internal cavity 52, and each channel 62 includes an open end 63 disposed adjacent the teeth 46 (see FIG. 9). As will be explained below, during operation of the rotary cutting tool 20 a plug 58 will enter the internal cavity 52. The portion of each channel 62 open to the internal cavity 52 permits cutting fluid to enter the channel 62 and the open end 63 of the channel 62 permits cutting fluid within the channel to exit the channel 62 adjacent the teeth 46. The channels 62 are spaced apart from one another around the circumference of the interior wall surface 54; e.g., equi-spaced from one another. Each channel 62 may be described as having a width 64, a depth 66, and a widthwise cross-sectional area (e.g., see FIG. 4A). The end view shown in FIG. 4 diagrammatically shows a plurality of channels 62, each having a cross-section with an arcuate shape, but the present disclosure in not limited to any particular channel 62 shape. In the embodiment shown in FIG. 4, the channels 62 extend axially along the interior wall surface 54, each thereby providing a fluid channel from about the base 56 of the internal cavity 52 to the teeth 46. Also in FIG. 4 (and expanded view FIG. 4A), each channel 62 is disposed adjacent a tooth 46, but also may be described as being disposed “forward” of the adjacent following tooth 46. The term “forward” as used herein refers to the relative circumferential positions of the channel 62 and the adjacent tooth 46; i.e., during rotation of the rotary cutting tool 20 the channel 62 will pass a given point during rotation of the tool 20 prior to adjacent tooth 46 passing the same point. As indicated by arrow 68, the rotary cutting tool 20 shown in FIG. 4 is configured for counter-clockwise rotation. As will be described below, the forward position of a channel 62 relative to a following tooth 46 enables cutting fluid exiting the channel 62 (e.g., via the open end 63 of the channel 62) to wash radially outwardly in front of the following tooth 46 (identified as “46FT” in FIGS. 4, 4A, 8, and 9) to facilitate removal of cutting debris into a respective flute 38. The configuration of each channel 62 (e.g., width, depth, cross-sectional area) and the number of channels 62 can be selected to collectively provide a volumetric fluid flow rate and fluid pressure profile that is adequate for the material being cut and the type of cutting fluid being used during the cutting process.

The cutting teeth section 36 includes a plurality of teeth 46 disposed at the cutting end 28 of the tool 20, extending axially between the fluted section 34 and the cutting end 28. The teeth 46 are circumferentially spaced apart from one another, with a void (sometimes referred to as a “gullet 48”) disposed between each set of adjacent teeth 46. The exemplary rotary cutting tool 20 shown in the FIGURES includes five (5) teeth 46 disposed within the cutting teeth section 36. The present disclosure rotary cutting tool 20 is not limited to any particular number of teeth 46, other than having at least two teeth 46.

Referring to FIGS. 4-7A, 9A, and 9B, each tooth 46 includes a front side 70, an aft side 72, an exterior side 74, an interior side 76, and an axial end side 78. The front side 70 is the forward of the aft side 72, and is disposed on the opposite side of the tooth 46 relative to the aft side 72. The exterior side 74 is disposed radially outside of the interior side 76, and the exterior side 74 is disposed on the opposite side of the tooth 46 relative to the interior side 76. The axial end side 78 is the axial end of the tooth 46. Each of the front side 70, exterior side 74, interior side 76, aft side 72, and axial end side 78 includes at least one surface.

A front side surface 80 disposed at the front side 70 may be referred to as a “rake face”. An exterior side surface 82 intersects with the front side surface 80 to form an exterior cutting edge 84, an interior side surface 86 intersects with the front side surface 80 to form an interior cutting edge 88, and an axial end surface 90 intersects with the front side surface 80 to form an axial end cutting edge 92. In some embodiments, the front side surface 80 may include an inner edge 94 disposed at the axial end of the front side surface 80 opposite the axial end cutting edge 92 (see FIGS. 9A and 9B). In these embodiments, therefore, the front side surface 80 may be described as extending axially between the axial end cutting edge 92 and the inner edge 94, and extending radially between the exterior cutting edge 84 and the interior cutting edge 88. In some embodiments, the exterior side surface 82 includes an aft edge 96, an inner axial edge 97, and an outer axial edge 99. The outer axial edge 99 is defined by the intersection between the exterior side surface 82 and the axial end surface 90. In these embodiments, therefore, the exterior side surface 82 may be described as extending axially between the inner axial edge 97 and the outer axial edge 99, and extending in a circumferential direction between the exterior cutting edge 84 and the aft edge 96. In some embodiments, the interior side surface 86 includes an aft edge 98, an inner axial edge 101, and an outer axial edge 103. The outer axial edge 103 is defined by the intersection between the interior side surface 86 and the axial end surface 90. In these embodiments, therefore, the interior side surface 86 may be described as extending axially between the inner axial edge 101 and the outer axial edge 103, and extending in a circumferential direction between the interior cutting edge 88 and the aft edge 98. In some embodiments, the axial end surface 90 includes an aft edge 100. In these embodiments, therefore, the axial end surface 90 may be described as extending radially between the outer axial edge 99 of the exterior side surface 82 and the outer axial edge 103 of the interior side surface 86, and extending in a circumferential direction between the axial end cutting edge 92 and the aft edge 100.

The intersection point of the exterior side surface 82, the front side surface 80, and the axial end surface 90 (referred to hereinafter as the “outer radial tip 102”) is disposed at a radial position outside of the outer diameter of the fluted section 34; i.e., the radius of the aforesaid outer radial tip 102 from the central axis 24 is greater than the radius of the fluted section 34 exterior surface 40 from the central axis 24. Hence, the outer radial tip 102 may be described as being “proud” of the exterior surface 40 of the fluted section 34. In some embodiments, the entirety of the exterior cutting edge 84 (i.e., the edge formed by the intersection of the exterior side surface 82 with the front side surface 80) may be “proud” of the exterior surface 40 of the fluted section 34.

The intersection point of the interior side surface 86, the front side surface 80, and the axial end surface 90 (referred to hereinafter as the “inner radial tip 104”) is disposed at a radial position inside of the interior wall surface 54 of the internal cavity 52; i.e., the radius of the aforesaid inner radial tip 104 from the central axis 24 is less than the radius of the interior wall surface 54 of the internal cavity 52 from the central axis 24. Hence, the inner radial tip 104 may be described as being “proud” of the interior wall surface 54 of the internal cavity 52. In some embodiments, the entirety of the interior cutting edge 88 (i.e., the edge formed by the intersection of the interior side surface 86 with the front side surface 80) may be “proud” of the interior wall surface 54 of the internal cavity 52.

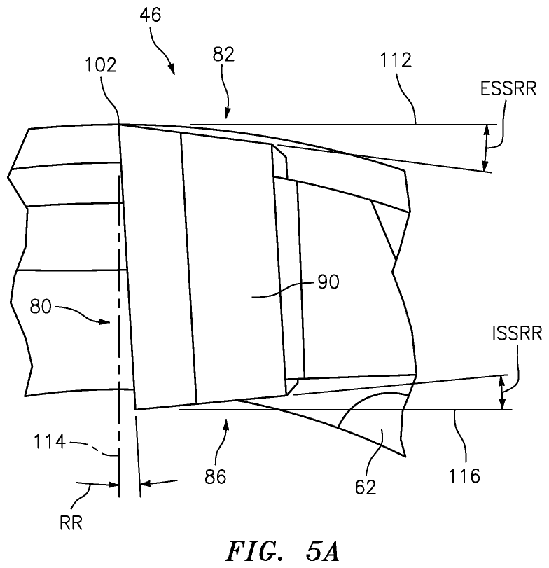

Referring to FIGS. 4A, 5, and 5A, in some embodiments the front side surface 80 of each tooth 46 (i.e., the rake face) is skewed by an acute radial rake angle “RR” relative to a radial line 106 extending out from the central axis 24 that is tangential to the exterior cutting edge 84. As a result of the angle RR, the exterior cutting edge 84 of the tooth 46 is disposed forward of the interior cutting edge 88 at any given axial position of the exterior cutting edge; i.e., at a given axial position where the radial line 106 is tangential to the exterior cutting edge 84, the exterior cutting edge is forward of the interior cutting edge 88. The magnitude of the acute angle RR can be varied to best suit the rotary cutting tool 20 for different applications; e.g., different types of substrate 60 materials, rotational cutting speeds, etc. The present disclosure is not limited to any particular angle RR value.

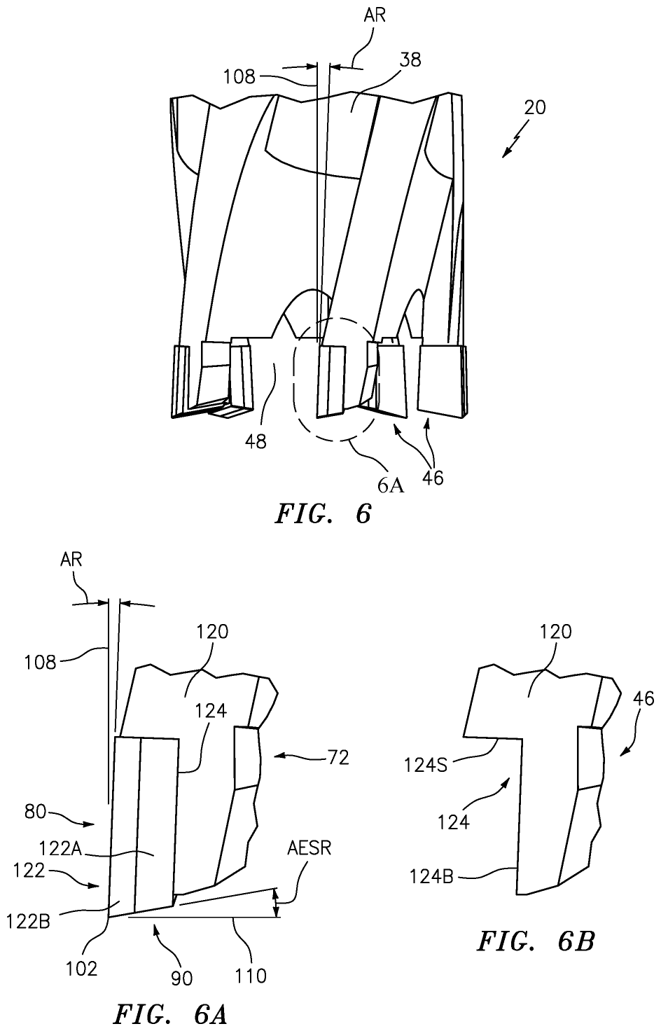

Referring to FIG. 6, in some embodiments the front side surface 80 of each tooth 46 (i.e., the rake face) is skewed by an acute axial rake angle “AR” relative to a line 108 extending parallel with the central axis 24 of the rotary cutting tool 20 that is tangential to the axial end cutting edge 92. As a result of the angle AR, the axial end cutting edge 92 of the tooth 46 is disposed circumferentially forward of the front side surface 80 inner edge 94 at any given radial position of the axial end cutting edge 92; i.e., at a given radial position where the line 108 is tangential to the axial end cutting edge 92, the axial end cutting edge 92 is circumferentially forward of the front side surface inner edge 94 (e.g., see FIGS. 9A and 9B). The magnitude of the acute angle AR can be varied to best suit the rotary cutting tool 20 for different applications; e.g., different types of substrate materials, rotational cutting speeds, etc. The present disclosure is not limited to any particular angle AR value.

Referring to FIG. 6A, in some embodiments the axial end surface 90 is skewed by an acute axial end surface relief angle “AESR” relative to a circumferential line 110 that is tangential to the outer radial tip 102, and that is perpendicular to the central axis 24. As a result of the angle AESR, the axial end cutting edge 92 is axially displaced from the aft edge 100 of the axial end surface 90; i.e., the axial end cutting edge 92 is disposed axially outside of the aft edge 100 of the axial end surface 90 (e.g., see FIGS. 9A and 9B). The magnitude of the acute angle AESR can be varied to best suit the rotary cutting tool 20 for different applications; e.g., different types of substrate 60 materials, rotational cutting speeds, etc. The present disclosure is not limited to any particular angle AESR value.

Referring to FIGS. 5 and 5A, in some embodiments the exterior side surface 82 of each tooth 46 is skewed by an acute exterior side surface radial relief angle “ESSRR” relative to a line 112 that is tangential to the exterior cutting edge 84 (e.g., see FIGS. 9A and 9B) and perpendicular to a radial line 114 extending out from the central axis 24 (as can be seen in FIG. 5, radial line 106 and radial line 114 may be collinear). As a result of the angle ESSRR, the exterior cutting edge 84 of the tooth 46 is disposed radially outside of the aft edge 96 of the exterior side surface 82. The magnitude of the acute angle ESSRR can be varied to best suit the rotary cutting tool 20 for different applications; e.g., different types of substrate 60 materials, rotational cutting speeds, etc. The present disclosure is not limited to any particular angle ESSRR value.

Referring to FIGS. 5 and 5A, in some embodiments the interior side surface 86 of each tooth 46 is skewed by an acute interior side surface radial relief angle “ISSRR” relative to a line 116 that is tangential to the interior cutting edge 88 and perpendicular to a radial line 114 extending out from the central axis 24. As a result of the angle ISSRR, the interior cutting edge 88 (e.g., see FIGS. 9A and 9B) of the tooth 46 is disposed radially inside of the aft edge 98 of the interior side surface 86. The magnitude of the acute angle ISSRR can be varied to best suit the rotary cutting tool 20 for different applications; e.g., different types of substrate materials, rotational cutting speeds, etc. The present disclosure is not limited to any particular angle ISSRR value.

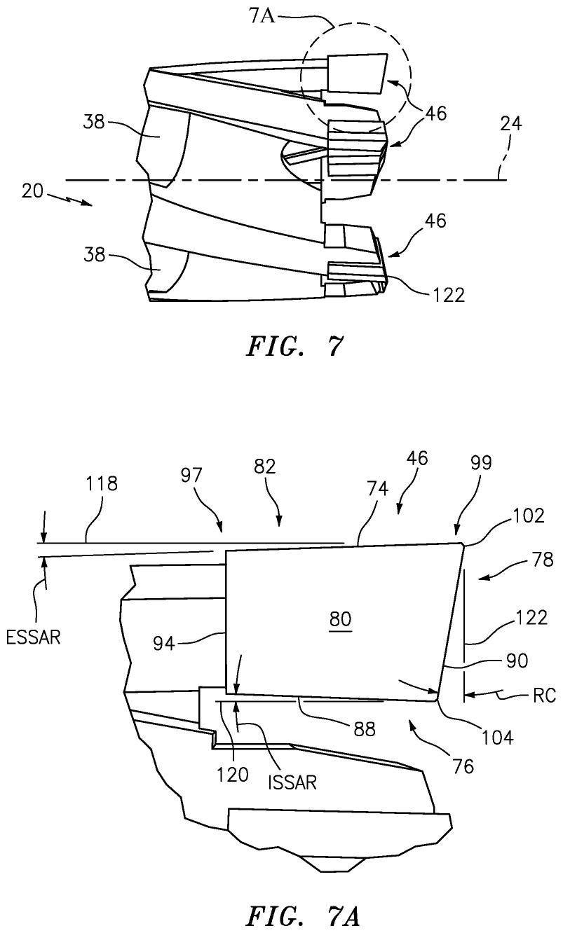

Referring to FIGS. 7 and 7A, in some embodiments the exterior side surface 82 of each tooth 46 is skewed by an acute exterior side surface axial relief angle “ESSAR” relative to a line 118 that is tangential to the outer radial tip 102 and parallel to the central axis 24. As a result of the angle ESSAR, the outer axial edge 99 of the exterior side surface 82 is disposed radially outside of the inner axial edge 97 of the exterior side surface 82. The magnitude of the acute angle ESSAR can be varied to best suit the rotary cutting tool 20 for different applications; e.g., different types of substrate 60 materials, rotational cutting speeds, etc. The present disclosure is not limited to any particular angle ESSAR value.

In some embodiments the interior side surface 86 of each tooth 46 is skewed by an acute interior side surface axial relief angle “ISSAR” relative to a line 120 that is tangential to the inner radial tip 104 and parallel to the central axis 24. As a result of the angle ISSAR, the outer axial edge 103 of the interior side surface 86 is disposed radially inside of the inner axial edge 101 of the interior side surface 86. The magnitude of the acute angle ISSAR can be varied to best suit the rotary cutting tool 20 for different applications; e.g., different types of substrate 60 materials, rotational cutting speeds, etc. The present disclosure is not limited to any particular angle ISSAR value.

In some embodiments the axial end surface 90 of each tooth 46 is skewed by an acute radial cutting angle “RC” relative to a radial line 122 that is tangential to the outer radial tip 102, and that is perpendicular to the central axis 24. As a result of the angle RC, the axial position of the inner radial tip 104 is displaced from the outer radial tip 102; i.e., the outer radial tip 102 is disposed axially outside of the inner radial tip 104. To illustrate further, when the rotary cutting tool 20 is moved in a direction parallel to the central axis 24 into engagement with a planar substrate, the outer radial tip 102 will engage the substrate before the inner radial tip 104 as a result of the radial cutting angle RC. The entirety of the outer axial edge 99 of the exterior side surface 82 may be disposed axially outside of the outer axial edge 103 of the interior side surface 86. The magnitude of the acute angle RC can be varied to best suit the rotary cutting tool 20 for different applications; e.g., different types of substrate 60 materials, rotational cutting speeds, etc. The present disclosure is not limited to any particular angle RC value.

The geometric configuration of the outer radial tip 102 may be varied to best suit the rotary cutting tool 20 for different applications; e.g., different types of substrate materials, rotational cutting speeds, etc. For example, the outer radial tip 102 may be configured with a radius, a multi-radius arcuate shape, a chamfer, or the like.

The geometric configuration of the inner radial tip 104 may be varied to best suit the rotary cutting tool 20 for different applications; e.g., different types of substrate materials, rotational cutting speeds, etc. For example, the inner radial tip 104 may be configured with a radius, a multi-radius arcuate shape, a chamfer, or the like.

In some embodiments, each tooth 46 may be formed completely from the same material as the body 22 of the rotary cutting tool 20 (e.g., the entirety of the tooth 46 may be formed by removing surrounding tool material via a machining process). In these embodiments, the tool 20 may be described as a unitary structure. In some embodiments, each tooth 46 may be formed to include a pedestal portion 120 formed from the same material as the body 22 of the rotary cutting tool 20. One or more inserts 122 may be attached to the pedestal portion 120 of the tooth 46 to complete the respective tooth 46.

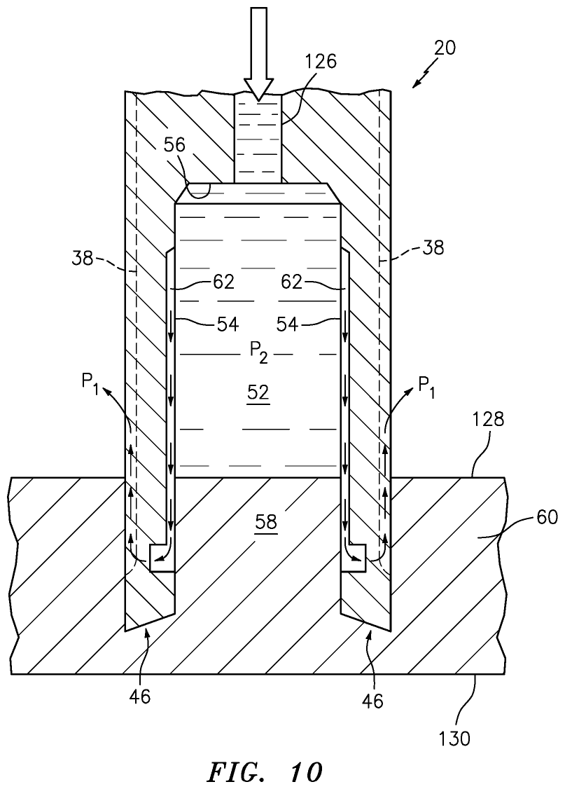

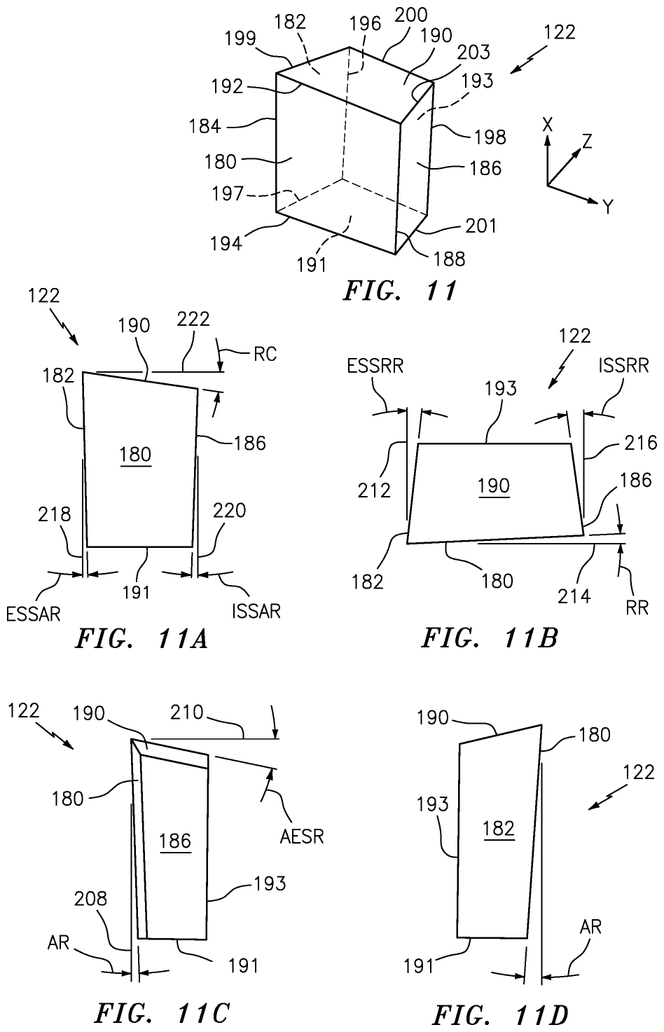

In the exemplary embodiment shown in FIGURES, for example, the pedestal portion 120 is formed to include a pocket 124 configured to receive one or more inserts 122 (e.g., see FIG. 6B). The pedestal pocket 124 may include a seat surface 124S and a back surface 124B. The pocket seat surface 124S is configured to contact a base surface 191 of an insert 122 (see FIG. 11), and the pocket back surface 124S is configured to contact an aft surface 193 of an insert 122 when the insert 122 is mounted within the pocket 124. Each pedestal pocket 124 may be configured to receive an insert(s) that is geometrically configured to produce the tooth surface angle characteristics described above. Alternatively, a pedestal pocket 124 may be configured to receive an insert 122 that itself is not configured to provide the one or more of the surface angle characteristics described above, but upon the insert being received and attached to the pedestal 124, the aforesaid configuration characteristic(s) is achieved; e.g., a pedestal pocket 124 may be oriented relative to radial and axial lines of the tool 20 (e.g., skewed) such that the aforesaid surface angle(s) is present when the insert 122 is installed, but is not present in the insert 122 itself.

Non-limiting examples of inserts 122 include carbide inserts, superhard material inserts, carbide inserts with superhard material grown on one or more surfaces of the carbide insert, etc. The present disclosure is not limited to any particular insert material. The term “superhard material” is understood to be an industry term referring to particular types of materials. Non-limiting examples of superhard materials include natural diamond, chemical vapor deposition diamond (CvD), and polycrystalline superhard materials (PSHM) such as polycrystalline diamond (PCD) and polycrystalline cubic boron nitride (PcBN). The embodiment shown in the FIGURES include a carbide support insert 122A and a superhard material insert 122B both disposed within the pedestal pocket 124, and both fixed (e.g., by braze, adhesive, mechanical attachment, etc.) to the pedestal portion 120. In this example, the carbide support insert 122A is disposed between an aft surface of the pocket 124 and the superhard material insert 122B. In the above example, the superhard material insert 122B forms a portion or all of the front side surface 80, the exterior side surface 82, the interior side surface 86, and axial end surface 90. As stated above, the exemplary insert 122 that includes a carbide support insert 122A portion and a superhard material insert 122B portion is an example, and the present disclosure is not limited thereto.

In some embodiments (including those described above), each tooth 46 may include a coating applied to particular surfaces of the tooth 46 (e.g., at least one of the front side surface 80, the exterior side surface 82, the interior side surface 86, or the axial end surface 90). Examples of coatings include chemical vapor deposition diamond (CvD)

To be clear, although the rotary cutting tool 20 shown in the FIGURES includes inserts attached to a pedestal portion 120 of the tooth 46, the present disclosure is not limited to a rotary cutting tool 20 having teeth 46 with inserts 122. As stated above, in some embodiments each tooth 46 may be formed completely from the same material as the body 22 of the rotary cutting tool 20; i.e., the rotary cutting tool 20 is a unitary structure comprising the same material throughout, including the teeth 46. These unitary embodiments of the rotary cutting tool 20 may include a coating applied to particular surfaces of each tooth 46.

The rotary cutting tool body 22 includes at least one fluid passage 126 extending internally within the body 22 from the shank end 26 of the body 22 to the base 56 of the internal cavity 52. The at least one fluid passage 126 is configured to permit a fluid (e.g., a cutting fluid) entry at the shank end 26 of the rotary cutting tool body 22 and passage through the tool body 22 to the internal cavity 52.

As described herein, the present disclosure rotary cutting tool 20 is configured for use with a rotary machine tool configured for driving the rotary cutting tool 20, which rotary machine tool includes a pressurized cutting fluid system configured to feed cutting fluid (gas or liquid) to the shank end 26 of the rotary cutting tool 20. Hence, the present disclosure includes a system that includes a rotary machine tool having a pressurized cutting fluid source and at least one rotary cutting tool 20 as described herein.

Referring to FIGS. 11-11D, according to an aspect of the present disclosure, an insert 122 for a rotary cutting tool is provided. As described above, the insert 122 may be a unitary body or may be formed from a plurality of insert portions; e.g., carbide support insert 122A portion and superhard material insert 122B portion. The insert 122 includes a front side surface 180 (i.e., a “rake face”), an exterior side surface 182, an interior side surface 186, an axial end surface 190, a base surface 191, and an aft surface 193. The insert may be described as extending heightwise (shown as the “X” axis in the orthogonal legend in FIG. 11) between the axial end surface 190 and the base surface 191, widthwise (shown as the “Y” axis) between the exterior side surface 182 and the interior side surface 186, and depthwise (shown as the “Z” axis) between the front side surface 180 and the aft surface 193. The exterior side surface 182 intersects with the front side surface 180 to form an exterior cutting edge 184, an interior side surface 186 intersects with the front side surface 180 to form an interior cutting edge 188, and an axial end surface 190 intersects with the front side surface 180 to form an axial end cutting edge 192. The front side surface 180 includes an inner edge 194 disposed at an end of the front side surface 180 opposite the axial end cutting edge 192. The front side surface 180 may be described as extending in a heightwise direction between the axial end cutting edge 192 and the inner edge 194, and extending in an orthogonal widthwise direction between the exterior cutting edge 184 and the interior cutting edge 188. The exterior side surface 182 includes an aft edge 196, an inner axial edge 197, and an outer axial edge 199. The outer axial edge 199 is defined by the intersection between the exterior side surface 182 and the axial end surface 190. The exterior side surface 182 may, therefore be described as extending in a heightwise direction between the inner axial edge 197 and the outer axial edge 199, and extending in an orthogonal depthwise direction between the exterior cutting edge 184 and the aft edge 196. The interior side surface 186 includes an aft edge 198, an inner axial edge 201, and an outer axial edge 203. The outer axial edge 203 is defined by the intersection between the interior side surface 186 and the axial end surface 190. The interior side surface 186 may, therefore, be described as extending in a heightwise direction between the inner axial edge 201 and the outer axial edge 203, and extending in an orthogonal depthwise direction between the interior cutting edge 188 and the aft edge 198. The axial end surface 190 includes an aft edge 200. The axial end surface 190 may be described as extending in a widthwise direction between the outer axial edge 199 of the exterior side surface 182 and the outer axial edge 203 of the interior side surface 186, and extending in an orthogonal depthwise direction between the axial end cutting edge 192 and the aft edge 200. In some embodiments, the aft surface 193 may be perpendicular to the base surface 191

Referring to FIG. 11B, in some embodiments the front side surface 180 of an insert 122 (i.e., the rake face) may be skewed by an angle “RR”. As a result of the angle RR, the distance between the front side surface 180 and the aft surface 193 along the interior side surface 186 is less than the distance between the front side surface 180 and the aft surface 193 along the exterior side surface 182 at the same heightwise position. The line 214 defining the angle “RR” is parallel to the widthwise axis Y. In those embodiments wherein the aft surface 193 and the base surface 191 are perpendicular one another, the line 214 is parallel to the aft surface 193. The angle “RR” is described above in the context of a tooth 46.

Referring to FIGS. 11C and 11D, in some embodiments the front side surface 180 of an insert 122 may be skewed by an angle “AR”. The line 208 defining the angle “AR” is parallel to the heightwise axis X. In those embodiments wherein the aft surface 193 and the base surface 191 are perpendicular one another, the line 208 is parallel to the aft surface 193. The angle “AR” is described above in the context of a tooth 46.

Referring to FIG. 11C, in some embodiments the axial end surface 190 of an insert 122 may be skewed by an angle “AESR”. The line 210 defining the angle “AESR” is parallel to the depthwise axis Z. In those embodiments wherein the aft surface 193 and the base surface 191 are perpendicular one another, the line 210 is parallel to the base surface 191. The angle “AESR” is described above in the context of a tooth 46.

Referring to FIG. 11B, in some embodiments the exterior side surface 182 of an insert 122 may be skewed by an angle “ESSRR”. The line 212 defining the angle “ESSRR” is parallel to the depthwise axis Z. In those embodiments wherein the aft surface 193 and the base surface 191 are perpendicular one another, the line 212 is perpendicular to the aft surface 193. The angle “ESSRR” is described above in the context of a tooth 46.

Referring to FIG. 11B, in some embodiments the interior side surface 186 of an insert 122 may be skewed by an angle “ISSRR”. The line 216 defining the angle “ISSRR” is parallel to the depthwise axis Z. In those embodiments wherein the aft surface 193 and the base surface 191 are perpendicular one another, the line 216 is perpendicular to the aft surface 193. The angle “ISSRR” is described above in the context of a tooth 46.

Referring to FIG. 11A, in some embodiments the exterior side surface 182 of an insert 122 may be skewed by an angle “ESSAR”. The line 218 defining the angle “ESSAR” is parallel to the heightwise axis X. In those embodiments wherein the aft surface 193 and the base surface 191 are perpendicular one another, the line 218 is perpendicular to the base surface 191. The angle “ESSAR” is described above in the context of a tooth 46.

Referring to FIG. 11A, in some embodiments the interior side surface 186 of an insert 122 may be skewed by an angle “ISSAR”. The line 220 defining the angle “ISSAR” is parallel to the heightwise axis X. In those embodiments wherein the aft surface 193 and the base surface 191 are perpendicular one another, the line 220 is perpendicular to the base surface 191. The angle “ISSAR” is described above in the context of a tooth 46.

Referring to FIG. 11A, in some embodiments the axial end surface 190 of an insert 122 may be skewed by an angle “RC”. The line 222 defining the angle “RC” is parallel to the widthwise axis Y. In those embodiments wherein the aft surface 193 and the base surface 191 are perpendicular one another, the line 222 is parallel to the base surface 191. The angle “RC” is described above in the context of a tooth 46.

The diagrammatic depictions of an insert embodiment shown in FIGS. 11-11D are not intended to be to scale. The angles described above may be very small in magnitude and therefore not easily discernible if shown to scale. Hence, the aforesaid surface angles shown in FIGS. 11-11D are exaggerated to facilitate the explanation. In addition, the above description provides that an insert may include surface angles RC, ESSAR, ISSAR, AR, RR, ESSRR, and ISSRR, each greater than zero degrees. The present disclosure contemplates that insert embodiments may include one or more of these angles surfaces or all of these angles surfaces.

In the operation of the rotary cutting tool 20, a length of the shank portion 30 is fixed within a chuck of a rotary machine tool. The rotary machine tool is configured to rotationally drive the rotary cutting tool 20 at one or more selected rotational speeds. The rotary machine tool includes a cutting fluid source that provides cutting fluid to the shank end 26 of the rotary cutting tool 20 and internal fluid passage 126 at a selected pressure (greater than ambient) and volumetric flow rate. The particular cutting fluid used in the cutting process, which may be a gas or a liquid, may depend on several factors such as, but not limited to, the mechanical and material properties of the substrate material being cut, the thickness of the substrate 60, the feed rate of the cutting device, and the like. The present disclosure rotary cutting tool 20 is not limited to use with any particular type of cutting fluid, or any particular cutting fluid volumetric flow rate and/or supply pressure. However, as described herein, the number of channels 62 disposed in the interior wall surface 54 of the internal cavity 52, and the geometric configuration of those cavities 52, is typically selected to provide a cutting fluid flow rate and pressure profile that is acceptable for the substrate 60 being cut, the applied machine operational parameters, and the type of cutting fluid being used during the cutting process.

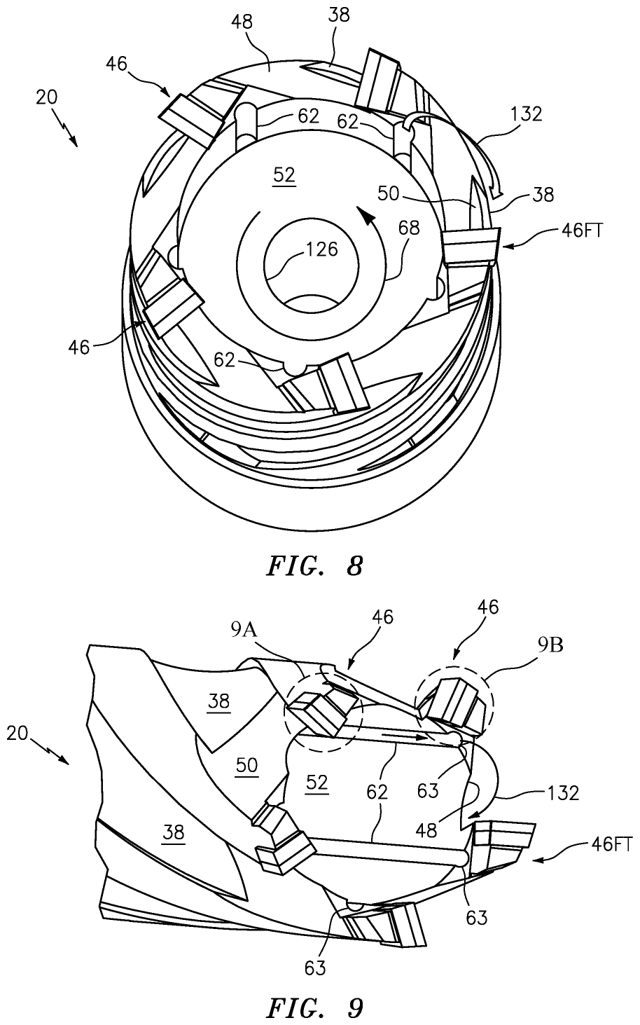

Referring to FIGS. 8-10, as the rotary cutting tool 20 engages a first surface 128 of the substrate 60, the cutting teeth 46 begin to cut an annular void within the substrate 60. The annular void defines a central core of substrate 60 material (i.e., a “plug 58”) that enters the internal cavity 52 of the tool as the cutting proceeds. The portion of the internal cavity 52 devoid of the plug 58 fills with cutting fluid at an elevated pressure “P₂” greater than ambient pressure “P₁” from the fluid passage 126. Cutting fluid within the internal cavity 52 exits the internal cavity 52 of the rotary cutting tool 20 via the channels 62 (e.g., the open ends 63 of the channels 62; shown diagrammatically in FIG. 10) disposed within the interior wall surface 54 of the internal cavity 52. As stated above, the channels 62 (e.g., collective number and individual geometric configuration) create a cutting fluid volumetric flow rate to the teeth 46 and a pressure profile between the internal cavity 52 and the ambient surroundings across that is acceptable for the material being cut and the type of cutting fluid being used during the cutting process. For example, the channels 62 are typically configured to provide a cutting fluid flow that is adequate to remove debris created during the cutting process as will be described below. The channels 62 are also typically configured so that the fluid pressure within the internal cavity 52 itself does not cause deformation of the plug 58 during the cutting process (e.g., plug 58 flexure when cutting thin substrates 60), or substrate material failure and premature separation of the plug 58, or substrate surface deformations surrounding the aperture and/or within the substrate itself, but rather the channels 62 are configured to establish a fluid pressure within the internal cavity 52 is sufficient to remove the plug 58 from the internal cavity 52 upon completion of the cutting process without detrimental effect to the substrate 60.

Each channel 62 within the interior wall surface 54 of the internal cavity 52 is positioned forward of a respective tooth 46 (e.g., described above as a “following tooth 46FT”). A respective flute 38 inlet (shown diagrammatically in FIG. 10) is disposed adjacent the following tooth 46 (e.g., see FIGS. 8 and 9). The relative positions of each respective channel 62, flute 38 and tooth 46 is such that cutting fluid 132 exiting the channel 62 passes between a pair of adjacent teeth 46 and passes in front of the aft tooth 46 (i.e., the following tooth 46FT) of the pair of teeth 46. The cutting fluid 132 exiting the channel 62 may be described as “washing” across the gullet 48 between the pair of adjacent teeth 46, in front of the following tooth 46FT where cutting debris is captured by the cutting fluid flow 132, and enters the flute 38 adjacent the following tooth 46. The substrate 60 being cut creates one or more surfaces that bound the teeth 46 that effectively enclose the teeth 46, thereby forming a part of a fluid passage for cutting fluid to pass from a respective channel 62 to a respective flute 38. The cutting fluid with cutting debris subsequently passes within the flute 38 and exits outside of the substrate 60. The pressure difference between the cutting fluid residing within the internal cavity 52 (at P₂) and the ambient pressure surrounding the substrate 60 (at P₁) provides a motive force acting on the cutting fluid propelling it along the aforesaid path. In those rotary cutting tool 20 embodiments having helical flutes 38, the rotation of the rotary cutting tool 20 may provide additional motive force for the removal of the cutting fluid and captured debris.

The angled surfaces of each tooth 46 (e.g., one or more of the ESSRR, ISSRR, ESSAR, ISSAR, and AESR angles) decrease the amount of contact between the tooth 46 and the substrate 60 and thereby reduce friction. As indicated above, thermal energy as a result of friction produced during the cutting process, if excessive, can produce undesirable thermal decomposition of a composite substrate. The decrease in friction associated with the angled surfaces of the present disclosure decreases the potential for excessive temperature. In those instances where the substrate 60 material being cut possesses some amount of elastic recovery, the aforesaid angled surfaces also account for the aforesaid elastic recovery.

The radial cutting angle RC (e.g., see FIG. 7A) provides significant advantages. For example as a result of the RC angle of each tooth 46, the forces applied to the substrate 60 by the present disclosure rotary cutting tool 20 are directed predominantly radially inwardly towards the plug 58 being cut and therefore predominantly away from the periphery of the substrate 60 surrounding the aperture being cut. The forces directed radially inward greatly reduce the potential for surface deformations and/or thermally caused degradation being formed within the entry and exit surfaces 128, 130 of the substrate 60 surrounding the aperture and/or within the body of the substrate 60. This characteristic of the present rotary cutting tool 20 is particularly advantageous when the substrate 60 being cut is a composite material having one or more fibrous layers where fibers may otherwise be frayed, or pulled during the cutting process. The ability of the present rotary cutting tool 20 to produce an aperture with significantly reduced deformations within the substrate can in many instances mitigate or eliminate the need to apply secondary machining processes to the substrate; e.g., deburring, chamfering, etc.

As stated above, the present disclosure provides rotary cutting tools 20 that provide a significant improvement for cutting apertures within composite substrates. Aspects of the present disclosure include a method for cutting a composite substrate. The cutting tool embodiments described above detail the tool characteristics that mitigate the potential for damage to the composite substrate during the cutting process. The above description also details a methodology wherein cutting fluid may from a fluid source may be provided to the internal cavity of the cutting tool and the fluid pressure within the internal cavity can be controlled (e.g., in view of the channels 62 disposed in the interior wall surface 54 of the internal cavity 52, to produce an acceptable fluid pressure level within the internal cavity 52 (e.g., sufficient to remove the plug upon completion, while not negatively affecting the composite substrate during the cutting process), and to provide a flow of cutting fluid through each channel that exits the channel 62 and washes across the gullet 48 between adjacent teeth 46 and removes cutting debris, carrying it to a respective flute 38.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities or a space/gap between the entities that are being coupled to one another.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed:

1. A rotary cutting tool cutting insert, comprising:
a front side surface;
an aft side surface opposite the front side surface;
an exterior side surface intersecting with the front side surface at an exterior cutting edge;
an interior side surface intersecting with the front side surface at an interior cutting edge, the interior side surface is opposite the exterior side surface;
an axial end side surface intersecting with the front side surface at an axial end cutting edge, and intersecting with the exterior side surface at a first outer axial edge, and intersecting with the interior side surface at a second outer axial edge; and
a base surface intersecting the front side surface, the exterior side surface, the interior side surface, and the aft surface, wherein the base surface intersects the front side surface at an inner edge, and the base surface is opposite the axial end side surface;
wherein the insert has a height axis that extends between the axial end side surface and the base surface, a width axis that extends between the exterior side surface and the interior side surface, and a depth axis that extends between the front side surface and the aft surface, and the height, width, and depth axes are orthogonal one another;
wherein an outer radial tip is disposed at a first widthwise end of the axial end cutting edge, and an inner radial tip is disposed at a second widthwise end of the axial end cutting edge, and the outer radial tip is disposed at a first heightwise distance from the inner edge, and the inner radial tip is disposed at a second heightwise distance from the inner edge, and the first heightwise distance is greater than the second heightwise distance.

2. The insert of claim 1, wherein the axial end cutting edge is skewed by an acute radial cutting angle, the radial cutting angle defined by the axial end cutting edge and a widthwise extending line parallel to the base surface.

3. The insert of claim 1, wherein the front side surface is skewed by an acute axial rake angle, the axial rake angle is defined by the front side surface and a heightwise extending line parallel to the aft surface.

4. The insert of claim 3, wherein the front side surface extends heightwise between the axial end cutting edge and an inner edge, and wherein the axial end cutting edge is disposed depthwise outside of the inner edge.

5. The insert of claim 1, wherein the front side surface is skewed by an acute radial rake angle, the radial rake angle is defined by the front side surface and a widthwise extending line parallel to the aft surface.

6. The insert of claim 5, wherein the exterior cutting edge is disposed depthwise outside of the interior cutting edge.

7. The insert of claim 1, wherein the axial end surface is skewed by an acute axial end surface relief angle, the axial end surface relief angle is defined by the axial end surface and a depthwise extending line that is perpendicular to aft surface.

8. The insert of claim 7, wherein the axial end side surface intersects with the aft surface at an aft edge, and the axial end surface extends depthwise between the axial end cutting edge and the aft edge, and wherein the axial end cutting edge is disposed heightwise outside of the inner edge of the front side surface.

9. The insert of claim 1, wherein the exterior side surface is skewed by an acute exterior side surface radial relief angle, the exterior side surface radial relief angle defined by the exterior side surface and a depthwise extending line that is perpendicular to the aft surface.

10. The insert of claim 9, wherein the exterior side surface extends depthwise between the exterior cutting edge and an aft edge, and wherein the exterior cutting edge is disposed widthwise outside of the aft edge.

11. The insert of claim 1, wherein the interior side surface is skewed by an acute interior side surface radial relief angle, the interior side surface radial relief angle defined by the interior side surface and a depthwise extending line that is perpendicular to the aft surface.

12. The insert of claim 11, wherein the interior side surface extends depthwise between the interior cutting edge and an aft edge, and wherein the interior cutting edge is disposed widthwise outside of the aft edge.

13. The insert of claim 1, wherein the exterior side surface is skewed by an acute exterior side surface axial relief angle, the exterior side surface axial relief angle defined by the exterior side surface and a line perpendicular to the base surface.

14. The insert of claim 13, wherein the exterior side surface extends heightwise between an outer axial edge and an inner axial edge, and wherein the outer axial edge is disposed widthwise outside of the inner axial edge.

15. The insert of claim 1, wherein the interior side surface is skewed by an acute interior side surface axial relief angle, the interior side surface axial relief angle defined by the interior side surface and a line perpendicular to the base surface.

16. The insert of claim 15, wherein the interior side surface extends heightwise between an outer axial edge and an inner axial edge, and wherein the outer axial edge is disposed widthwise outside of the inner axial edge.

17. The insert of claim 1, wherein the insert comprises a superhard material.

18. The insert of claim 1, wherein the insert comprises a carbide material.

19. The insert of claim 1, wherein the insert includes a plurality of insert portions attached to one another.

20. The insert of claim 1, wherein the insert is a unitary body.
